(19) United States
(12) Patent Application Publication
(10) Pub. No.: US 2020/0151753 A1
(43) Pub. Date: May 14, 2020

(54) VIRTUAL ID AND METHODS OF USE THEREOF

(71) Applicant: WPL Enterprise, LLC, St. Louis, MO (US)

(72) Inventor: Carol Watanabe, St. Louis, MO (US)

(21) Appl. No.: 16/682,703

(22) Filed: Nov. 13, 2019

Related U.S. Application Data
(60) Provisional application No. 62/760,418, filed on Nov. 13, 2018.

(51) Int. Cl. G06Q 30/02; G06Q 20/32; G06Q 20/38; G06Q 20/40

(52) U.S. Cl. CPC G06Q 30/0236; G06Q 20/4014; G06Q 20/387; G06Q 20/3224

(57) ABSTRACT

Disclosed herein is method for verifying the identity of an individual for receiving a benefit from an establishment, such as a discount. The method may include confirming, over an electronic network, a status of the individual; receiving a geolocation of the individual; receiving a location of an establishment within a set location of the individual's geolocation; and generating a virtual identification page to be shown to the establishment to receive the benefit. The virtual identification page includes the date, an active time counter, the establishment's name, and an identifier for the individual.

### CROSS REFERENCE TO RELATED APPLICATIONS

This application claims priority under 35 USC § 119(e) to U.S. Patent Application Ser. No. 62/760,418, filed on Nov. 13, 2018, the entire contents of which are hereby incorporated by reference.

### FIELD

The present invention relates generally to methods for verifying the identity of an individual.

### BACKGROUND

Businesses that would like to provide discounts or services to defenders (i.e. service members, veterans, police, fire and EMTs) often do not have a way of directing defenders to their location and/or ensure that only verified defenders are receiving the discounts.

Accordingly, there is a need for a way to verify the identity of an individual such that only verified individuals receive a benefit associated with an establishment, such as a discount.

### BRIEF SUMMARY

The disclosure provides for a method for verifying the identity of an individual. In some aspects, the method may include confirming, over an electronic network, a status of the individual; receiving a geolocation of the individual; receiving a location of an establishment within a set location of the individual's geolocation; and generating a virtual identification page operable to be shown to the establishment to receive a benefit. The virtual identification page may include the date, an active time counter, the establishment's name, and/or an identifier for the individual.

The identifier for the individual may be the individual's photograph, name, or combination thereof. The virtual identification page may further include the benefit for the establishment and/or a disclaimer. The benefit may be a discount. The set distance may be 20 meters. If an establishment is not within the set distance of the individual's geolocation, a virtual identification page is not generated. The virtual identification page expires when the geolocation of the individual is no longer within the set distance of the establishment's location. The method may further include searching for the establishment within a searching distance from the individual's geolocation. The searching distance is further than the set distance. The individual may be selected from active or veteran military, first responders, police, fire fighter, and/or EMT. The status of the individual may be based on their prior validation as active or veteran military, first responders, police, fire fighter, or EMT. The status may be approved or rejected. The method may further include confirming a status of the establishment.

In another aspect, at least one non-transitory computer readable medium storing instructions which when executed by at least one processor, may cause the at least one processor to: confirm a status of an individual; receive a geolocation of the individual; receive a location of an establishment within a set distance of the individual's geolocation; and generate a virtual identification page.

The virtual identification page may include the date, an active time counter, the establishment's name, and/or an identifier for the individual. The identifier for the individual may be the individual's photograph, name, or combination thereof. The virtual identification page may further include the benefit for the establishment and/or a disclaimer. The set distance may be 20 meters. The at least one processor may search for an establishment within a searching distance from the individual's geolocation. The individual may be selected from active or veteran military, first responders, police, fire fighter, and/or EMT. A status of the establishment may further be confirmed.

Additional aspects and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure.

### DESCRIPTION OF THE DRAWINGS

The description will be more fully understood with reference to the following figures, which are presented as variations of the disclosure and should not be construed as a complete recitation of the scope of the disclosure, wherein:

FIG. 1 shows a method of verifying the identity of an individual in an example.

FIG. 2 shows a method of verifying the identity of an individual and generating a virtual identification page in an example.

FIG. 3 shows an example of a computing system.

FIG. 4 shows an example virtual identification page.

FIG. 5 shows an example starting page with a selectable search radius.

### DETAILED DESCRIPTION

The method of verifying the identity of an individual will be understood from the accompanying drawings, taken in conjunction with the accompanying description. It is noted that, for purposes of illustrative clarity, certain elements in various drawings may not be drawn to scale. Several variations of the device are presented herein. It should be understood that various components, parts, and features of the different variations may be combined together and/or interchanged with one another, all of which are within the scope of the present application, even though not all variations and particular variations are shown in the drawings. It should also be understood that the mixing and matching of features, elements, and/or functions between various variations is expressly contemplated herein so that one of ordinary skill in the art would appreciate from this disclosure that the features, elements, and/or functions of one variation may be incorporated into another variation as appropriate, unless described otherwise.

For purposes of this description, “defender” refers to active or veteran military, first responders, police, fire fighter, and/or EMT.

### I. Method for Verifying the Identity of an Individual

Provided herein is a method for verifying the identity of an individual such that they may receive a benefit offered by an establishment only to verified individuals.

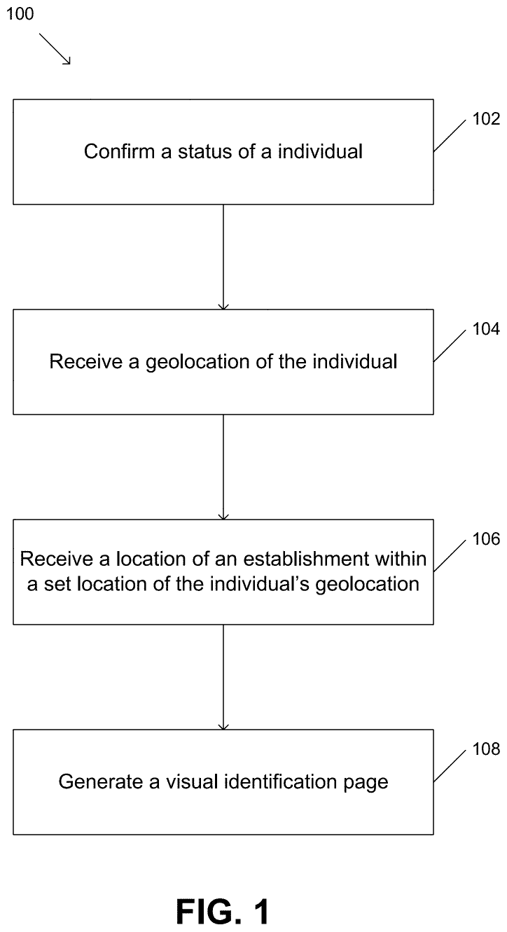

Referring to FIG. 1, a flowchart is presented in accordance with an example embodiment. The method 100 is provided by way of example, as there are a variety of ways to carry out the method. Each block shown in FIG. 1 represents one or more processes, methods or subroutines, carried out in the example method 100. Furthermore, the illustrated order of blocks is illustrative only and the order of the blocks can change according to the present disclosure. Additional blocks may be added or fewer blocks may be utilized, without departing from this disclosure.

The example method 100 is a method for verifying the identity of an individual. The example method 100 can begin at block 102. At block 102, a status of the individual may be confirmed. At block 104, a geolocation of an individual may be received. At block 106, a location of an establishment within a set distance of the individual's geolocation may be received. At block 108, a virtual identification page may be generated to be presented by the individual to the establishment. In some examples, the method may further include the individual receiving a benefit from the establishment.

The confirmation of the status of the individual allows for an establishment to know that the individual has been pre-confirmed as someone they would like to provide a benefit to, such as providing a discount to a defender. In some examples, the identity of the individual may be confirmed over an electronic network. The confirmation may include confirming that the individual is a defender. For example, individual may be active or veteran military, first responders, police, fire fighter, and/or EMT. In some examples, the status of the individual is based on their prior validation as active or veteran military, first responders, police, fire fighter, or EMT. In other examples, the individual may be required to provide proof of being a defender, such as an active military card. Based on the prior validation or provided proof, the status of the individual may be approved or rejected. The individual's status (ex. processing, approved, or rejected) may be stored for future use.

After an individual has confirmed their status as a defender, their geolocation may be acquired. The geolocation may be acquired from the individual's phone. In an example, the individual's geolocation may be a latitude and longitude within about 10 meters from the individual's phone. The individual's geolocation may be compared to a list of establishments providing benefits to verified individuals. In an example, the set distance may be 10 m, 20 m, 30 m, 40 m, 50 m, 60 m, 70 m, 80 m, 90 m, or 100 m. In at least one example, the set distance is about 20 meters. If no establishments are identified within the set distance, the individual may be asked if they want to recommend the location they are in. If the individual recommends their current location, the latitude and longitude of the individual may be submitted as recommendation for an establishment to provide a future benefit.

In another example, the individual's geolocation may be used to help the individual identify establishments within a searching distance from their location that are providing a benefit. In some examples, the searching distance may be longer than the set distance, such that the individual may need to travel to be within the set distance for the virtual identification page to be generated. In other examples, the searching distance may be less than or equal to the set distance. In an example, the searching distance may be about 10 m, 20 m, 30 m, 40 m, 50 m, 60 m, 70 m, 80 m, 90 m, or 100 m.

The geolocation allows for the establishment to confirm that the individual having the confirmed status is the same person at the establishment requesting the benefit. For example, if an establishment is not within the set distance of the individual's geolocation, a virtual identification page is not generated. In another example, the virtual identification page expires when the geolocation of the individual is no longer within the set distance, such as 20 m, of the establishment's location.

The method may further include confirming a status of the establishment. The status of the establishment may be active, probation, closed, or deleted

When the individual is ready to receive the benefit, a virtual identification page may be generated. The geolocation of the individual may be checked again to confirm that the individual is still within the set distance of the establishment. In some examples, the virtual identification page may be generated through an application on the individual's phone. The application may use location data for the matched establishment (ex. name, discount, disclaimer, and/or latitude/longitude), establishment status (ex. active, probation, closed, or deleted), individual location, and/or individual status to generate the virtual identification page if the individual's status and establishment's status are approved and active, respectively. In addition, the individual may be required to provide in-person verification before the virtual identification page is generated. Non-limiting examples of in-person verification include a 4 digit pin (set by the individual), face ID, or fingerprint ID.

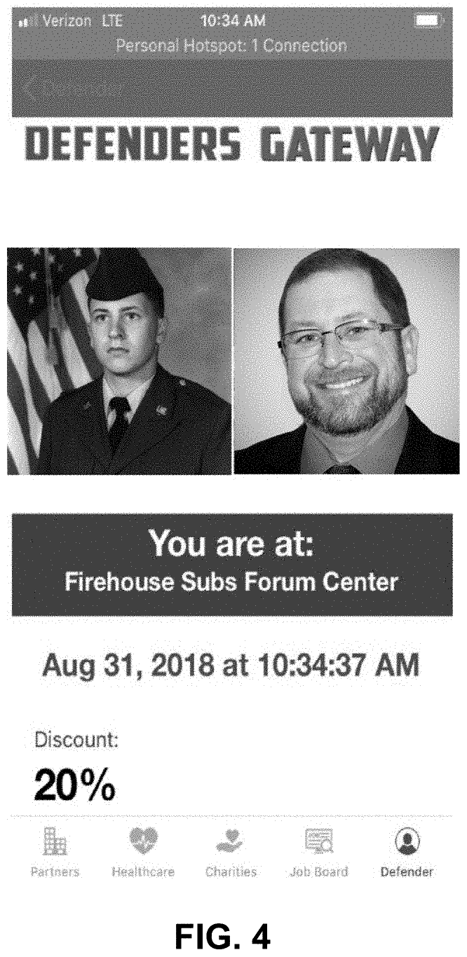

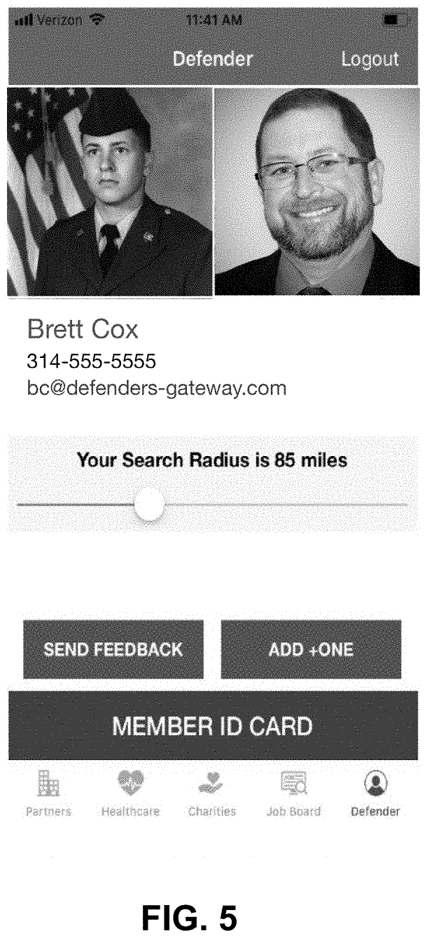

Once generated, the virtual identification page may be presented on the individual's phone. In some examples, the virtual identification page may include the date, an active time counter, the establishment's name, and/or an identifier for the individual. The virtual identification page allows the establishment to confirm that the individual requesting the benefit is the same individual that has been verified as a defender. The geolocation in combination with the display of the date and time counter help ensure that the verified individual is the person requesting the benefit. For example, the active counter prevents a screenshot of the benefit from being shared and/or used by someone other than the verified individual. The active counter may be constantly counting seconds, minutes, and hours since the virtual identification page was generated. In some examples, the identifier for the individual may be the individual's photograph, name, or combinations thereof. In some examples, the virtual identification page may further include the discount for the establishment and/or a discount disclaimer. FIG. 4 shows an example virtual identification page and FIG. 5 shows an example starting page with a selectable search radius.

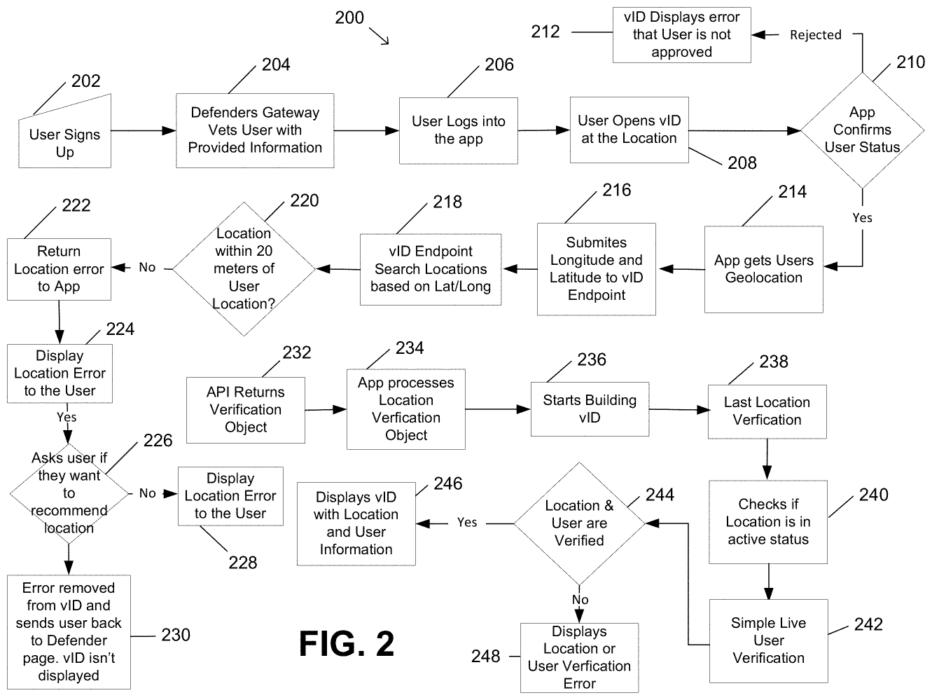

Referring to FIG. 2, a flowchart is presented in accordance with an example embodiment. The method 200 is provided by way of example, as there are a variety of ways to carry out the method. Each block shown in FIG. 2 represents one or more processes, methods or subroutines, carried out in the example method 200. Furthermore, the illustrated order of blocks is illustrative only and the order of the blocks can change according to the present disclosure. Additional blocks may be added or fewer blocks may be utilized, without departing from this disclosure.

The example method 200 is a method for verifying the identity of an individual. The example method 200 can begin at block 202. At block 202, the user signs up by providing information to show they are a defender. At block 204, the user is vetted using the provided information. At block 206, the user signs into the application. At block 208, the user opens the virtual identification (vID) of the application at the location of an establishment. At block 210, the status of the user is confirmed. If the user is rejected, the vID displays an error that the user is not approved, at block 212. At block 214, the application receives the user's geolocation if the user is approved. At block 216, the longitude and latitude of the geolocation are submitted to the vID endpoint. At block 218, the vID endpoint searches establishment locations based on the longitude and latitude. At block 220, the geolocation of the user is compared to the establishment location. At block 222, if the geolocation of the user is not within 20 meters of an establishment, a location error is returned. At block 224, a location error is displayed to the user. At block 226, the user is asked if they would like to recommend a location of a new establishment. If the user would like to recommend a location, the recommendation is sent to a recommendation server, at block 228. If the user does not have a recommendation, the vID is not displayed and the user is sent back to another page, at block 230. At block 232, the API returns a location verification object if the user is within 20 meters of the location of an establishment. At step 234, the location verification object is processed. At step 236, the vID is created. At step 238, the geolocation of the user and the location of the establishment are verified again. At step 240, the status of the establishment is checked to be active. At step 242, a live user verification is performed, such as a PIN, fingerprint, or face recognition. At step 244, the verification of the user and establishment are checked. At step 246, if the verification of the user and establishment are confirmed, then the vID with user and establishment information is displayed. At step 248, if the verification of the user or establishment is not confirmed, then a user or establishment location error is displayed.

### II. Computing System

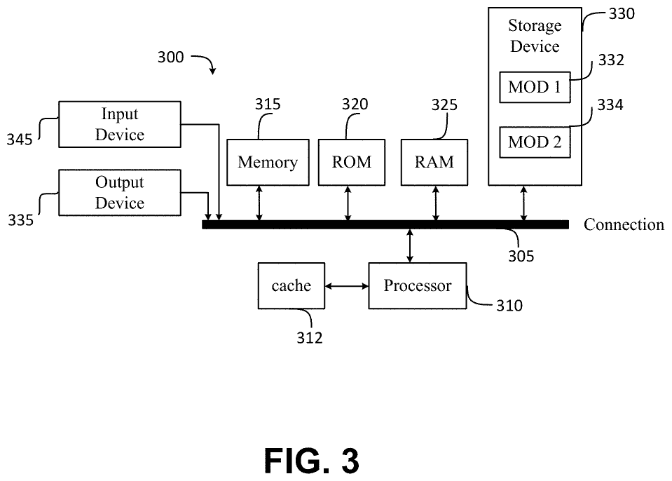

FIG. 3 shows an example of computing system 300 in which the components of the system are in communication with each other using connection 305. Connection 305 can be a physical connection via a bus, or a direct connection into processor 310, such as in a chipset or system-on-chip architecture. Connection 305 can also be a virtual connection, networked connection, or logical connection.

In some examples, one or more of the described system components represents many such components each performing some or all of the function for which the component is described. In some examples, the components can be physical or virtual devices.

Example computing system 300 includes at least one processing unit (CPU or processor) 310 and connection 305 that couples various system components including system memory 315, read only memory (ROM) 320 or random access memory (RAM) 325 to processor 310. Computing system 300 can include a cache of high-speed memory 312 connected directly with, in close proximity to, or integrated as part of processor 310.

Processor 310 can include any general purpose processor and a hardware service or software service, such as a location system 332 and data processing system 334 stored in storage device 330, configured to control processor 310 as well as a special-purpose processor where software instructions are incorporated into the actual processor design. Processor 310 may essentially be a completely self-contained computing system, containing multiple cores or processors, a bus, memory controller, cache, etc. A multi-core processor may be symmetric or asymmetric.

To enable user interaction, computing system 300 includes an input device 345, which can represent any number of input mechanisms, such as a touch-sensitive screen for gesture or graphical input, keyboard, mouse, or input from a sensor output portion. The input device 345 may be wired or wireless. Computing system 300 can also include output device 335, which can be one or more of a number of output mechanisms known to those of skill in the art. For example, the output device 335 may be a display. In some instances, multimodal systems can enable a user to provide multiple types of input/output to communicate with computing system 300. There is no restriction on operating on any particular hardware arrangement and therefore the basic features here may easily be substituted for improved hardware or firmware arrangements as they are developed.

Storage device 330 can be a non-volatile memory device and can be a hard disk or other types of computer readable media which can store data that are accessible by a computer, such as magnetic cassettes, flash memory cards, solid state memory devices, digital versatile disks, cartridges, battery backed random access memories (RAMs), read only memory (ROM), and/or some combination of these devices.

The storage device 330 can include software services, servers, services, etc., that when the code that defines such software is executed by the processor 310, it causes the system to perform a function. In some examples, a hardware service that performs a particular function can include the software component stored in a computer-readable medium in connection with the necessary hardware components, such as processor 310, connection 305, output device 335, etc., to carry out the function.

Provided herein is at least one non-transitory computer readable medium storing instructions which when executed by at least one processor, cause the at least one processor to confirm a status of an individual, receive a geolocation of the individual, receive a location of an establishment within a set distance of the individual's geolocation, and generate a virtual identification page. The individual may then present the virtual identification page to the establishment. In some examples, the individual receives a benefit, such as a discount, from the establishment after presenting the virtual identification.

The particular variations disclosed above are illustrative only, as the variations may be modified and practiced in different but equivalent manners apparent to those skilled in the art having the benefit of the teachings herein. It is therefore evident that the particular variations disclosed above may be altered or modified, and all such variations are considered within the scope and spirit of the application. Accordingly, the protection sought herein is as set forth in the description. Although the present variations are shown above, they are not limited to just these variations, but are amenable to various changes and modifications without departing from the spirit thereof. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed variations teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for verifying the identity of an individual comprising:
confirming, over an electronic network, a status of the individual;
receiving a geolocation of the individual;
receiving a location of an establishment within a set location of the individual's geolocation; and
generating a virtual identification page operable to be shown to the establishment to receive a benefit, wherein the virtual identification page includes the date, an active time counter, the establishment's name, and an identifier for the individual.

2. The method of claim 1, wherein the identifier for the individual is the individual's photograph, name, or combination thereof.

3. The method of claim 1, wherein the virtual identification page further includes the benefit for the establishment and/or a disclaimer.

4. The method of claim 1, wherein the benefit is a discount.

5. The method of claim 1, wherein the set distance is 20 meters.

6. The method of claim 1, wherein if an establishment is not within the set distance of the individual's geolocation, a virtual identification page is not generated.

7. The method of claim 1, wherein the virtual identification page expires when the geolocation of the individual is no longer within the set distance of the establishment's location.

8. The method of claim 1, further comprising searching for the establishment within a searching distance from the individual's geolocation.

9. The method of claim 8, wherein the searching distance is further than the set distance.

10. The method of claim 1, wherein the individual is selected from the group consisting of active or veteran military, first responders, police, fire fighter, and EMT.

11. The method of claim 10, wherein the status of the individual is based on their prior validation as active or veteran military, first responders, police, fire fighter, or EMT.

12. The method of claim 11, wherein the status is approved or rejected.

13. The method of claim 1, further comprising confirming a status of the establishment.

14. At least one non-transitory computer readable medium storing instructions which when executed by at least one processor, cause the at least one processor to:
confirm a status of an individual;
receive a geolocation of the individual;
receive a location of an establishment within a set distance of the individual's geolocation; and
generate a virtual identification page.

15. The at least one non-transitory computer readable medium of claim 14, wherein the virtual identification page includes the date, an active time counter, the establishment's name, and/or an identifier for the individual, and wherein the identifier for the individual is the individual's photograph, name, or combination thereof.

16. The at least one non-transitory computer readable medium of claim 14, wherein the virtual identification page further includes the benefit for the establishment and/or a disclaimer.

17. The at least one non-transitory computer readable medium of claim 14, wherein the set distance is 20 meters.

18. The at least one non-transitory computer readable medium of claim 14, storing instructions which when executed by at least one processor, further causing the at least one processor to search for the establishment within a searching distance from the individual's geolocation.

19. The at least one non-transitory computer readable medium of claim 14, wherein the individual is selected from the group consisting of active or veteran military, first responders, police, fire fighter, and EMT.

20. The at least one non-transitory computer readable medium of claim 14, further comprising confirming a status of the establishment.
